(19) United States
(12) Patent Application Publication
(10) Pub. No.: US 2012/0136864 A1
(43) Pub. Date: May 31, 2012

(54) Aggregation of Recipe Information, Meal Planning and Preparation

(76) Inventor: Robert Thomas Ochtel, Carlsbad, CA (US)

(21) Appl. No.: 13/297,539

(22) Filed: Nov. 16, 2011

Related U.S. Application Data
(60) Provisional application No. 61/418,132, filed on Nov. 30, 2010.

(51) Int. Cl. G06F 17/30

(52) U.S. Cl. 707/738; 707/E17.047

(57) ABSTRACT

A system for planning, preparation, and execution across multiple recipes and cookbooks simultaneously includes a database structure that distinguishes between different types of recipes stored in an electronic in the database. The system is further configured for performing actions such as scaling the recipe for a different number of servings, choosing between US and metric measurements, substituting ingredients, determining preparation times, determining needed cooking equipment, determining food parings from multiple cookbooks or series of cookbooks, determining wine pairings, and creating shopping lists. A corresponding method provides for users to search both e-Cookbooks and e-Recipes, where searching can be done on any number, combination of keywords or concepts.

### CROSS-REFERENCE TO RELATED APPLICATIONS

This application claims the benefit of U.S. Provisional Application No. 61/418,132, filed Nov. 30, 2010.

### TECHNICAL FIELD

Embodiments herein relate to aggregation of electronic cookbooks, cooking recipes, and tools that can extract information from cookbooks and e-recipes to provide assistance meal planning and preparation.

### BACKGROUND

Traditionally, recipes were found in cookbooks, advertisements and in product packages. Today, due to the advent of the Internet, recipes are available in electronic format through Internet sites. These websites allow users to search for individual recipes and download the same. A recipe comprises a list of ingredients, instructions, description, cooking time, preparation time, nutritional facts, serving size, and so on.

Digital e-Recipes are gaining more importance due to ease of access. Websites such as Allrecipes.com, epicurious.com, BigOven and foodnetwork.com are popular destinations for consumers to find, share, and organize individual recipes, both generated by individuals or from popular premium cooking sources (e.g., Chefs and cooking magazines). These websites do not provide eCookbooks, but individual eRecipes that do not necessarily relate to each other or are not organized in a traditional cookbook format. Therefore, recipe content on such websites is not and cannot be categorized in a structured Cookbook “library” format, providing ease of use, valuable information and enhanced utility to the consumer. Further, such websites only offer traditional “Digital Recipe Boxes”, which provide an “individual e-Recipe-based” data structure, offering a very limited means for organizing and retrieving e-Recipe content. In addition, “Digital Recipe Box” structures, make it impossible to aggregate recipe content from various of premium recipes sources (e.g., Book Publishers, Food Companies, Wineries, Magazines and Chefs, etc.), and present this e-Recipe data in a e-Cookbook “library” structure supporting the ability to then retrieve this same data from its original “cookbook” format and at the same time provide for a highly searchable format across all e-Cookbooks and e-Recipes within a database. Such an e-Cookbook “library” structure could be used to enhance the at-home chef's cooking experience when it comes to planning and preparing meals. It could also be used to aggregate e-Cookbook content across many premium recipe sources providing an invaluable tool for consumers and publishers alike. However, present systems do not enable providing information in a “library” structure.

Traditionally, most cookbooks have valuable cooking information at the front end, scattered throughout the cookbooks and within recipes themselves. This information provides valuable insights by providing additional recipe details, reference information, cooking techniques, tools, and cooking tips. This information could be used to enhance the at-home chef's cooking experience while providing predictable outcome and improved end results. However, in present systems such information is not integrated into individual e-Recipes contained within an eCookbook “library” data structure such that individual e-Recipes, contained in an e-Cookbook can reference information sources. Therefore, present systems limit the at-home chef's cooking experience and do not enable predicable end result.

Today, providers of e-cookbooks only allow the consumers to download the pdf version of the cookbook. This results in inherent limitations, manifesting themselves in at least a couple of ways. First, today's digital cookbooks are linear in function supporting flat file structure (for example, pdf file format). As such, e-cookbooks as provided today, do not support non-linear requirements of cooking (e.g., browsing, comparing and access to multiple cookbooks and their individual e-Recipes at the same time). Existing e-cookbooks lack the functionality of browsing through recipes, comparing recipes searchable across all e-cookbooks and providing access to multiple e-cookbooks through a single database. This results in a lack of utility for the at-home chef. Secondly, this flat-file structure does not allow for the integration of “tools” and individual e-Recipe Readers that provide recipe scaling, smart glossary, smart substitutions, integrated timers, adjusting serving size metrics, US/Metric conversions, wine-food/food-wine pairing, food-food pairings, etc., and, therefore, do not enhance the at-home chef cooking experience.

There is a need for a system that can aggregate premium cooking content from across multiple sources, extract valuable information from traditional hardcover cookbooks, integrate the necessary tools to support the meal planning and preparation process and provide an e-cookbook “library” storage and searchable format to enhance the at-home chef's cooking experience and at the same time provide for repeatable, and predictable results.

### SUMMARY

Accordingly, an embodiment of the invention provides method of providing access to series', cookbooks and recipes to a user through an electronic system which includes a user device and a centralized database. The method includes aggregating series, cookbook and recipe information from a plurality of sources, adding the aggregated series, cookbook and recipe information in the centralized database in a structured format and providing access to the aggregated series, cookbook and recipe information in the centralized database through the user device.

Further, another embodiment of the invention provides a system for providing access to series', cookbooks and recipes to a user. The system includes a user device, a centralized database, a means for aggregating series, cookbook and recipe information from a plurality of sources, a means for adding the aggregated series, cookbook and recipe information in the centralized database in a structured format, and a means for providing access to the aggregated series, cookbook and recipe information in the centralized database through the user device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments of this invention are illustrated in the accompanying drawings, throughout which like reference letters indicate corresponding parts in the various figures. The embodiments herein will be better understood from the following description with reference to the drawings, in which:

FIG. 1 is a flowchart showing the steps in meal preparation and planning, according to an embodiment herein;

FIG. 2 is a block diagram of an exemplary database to support meal preparation and planning, according to an embodiment herein;

FIG. 3 is a block diagram showing the relationship between the database of FIG. 2 and a target mea, according to an embodiment herein 1;

FIG. 4 is a flowchart describing the process of meal planning, according to an embodiment herein;

FIG. 5 is a flowchart describing the process of meal preparation, according to an embodiment herein;

FIG. 6A is a flowchart describing the process of using the glossary tool with a recipe, according to an embodiment herein;

FIG. 6B is a flowchart describing the process of using the glossary tool with an individual term or ingredient, according to an embodiment herein;

FIG. 7A is a flowchart describing the process of using the substitution tool with a recipe, according to an embodiment herein;

FIG. 7B is a flowchart describing the process of using the substitution tool with an individual ingredient, according to an embodiment herein;

FIG. 8 is a flowchart describing choosing a wine to go with food, according to an embodiment herein;

FIG. 9 is a flowchart describing choosing food to go with wine preference, according to an embodiment herein s;

FIG. 10 is a flowchart describing choosing food to go with other food, according to an embodiment herein;

FIG. 11 illustrates populating the database such that information is available to the system and tools, according to an embodiment herein;

FIG. 12 shows a eStore where the user can browse and purchase books from various series of cookbooks, according to an embodiment herein;

FIG. 13 shows a book detail view, according to an embodiment herein;

FIG. 14 shows a recipe information view, according to an embodiment herein;

FIG. 15 shows a view for organization of recipe information in books, according to an embodiment herein;

FIG. 16 shows a view for organization of recipe information, according to an embodiment herein;

FIG. 17 shows a recipe detail view, according to an embodiment herein;

FIG. 18 shows methods segment of a recipe detail view, according to an embodiment herein;

FIG. 19 shows the tools section under recipe detail view, according to an embodiment herein; and

FIG. 20 shows the shopping list view, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The terms “recipes”, “eRecipes” and electronic recipes have been used interchangeably through the specification, unless otherwise specified.

The terms “cookbooks”, “eCookbooks” and electronic cookbooks have been used interchangeably through the specification, unless otherwise specified.

The terms “series”, “eSeries” and electronic series have been used interchangeably through the specification, unless otherwise specified.

The term “series” refers to a collection of cookbooks, unless otherwise specified.

The term “cookbook” refers to a collection of recipes, unless otherwise specified.

The embodiments relate to a system, including database structures, and methods for aggregation of recipe information, assisting in meal planning, preparation, and execution across multiple recipes and cookbooks simultaneously.

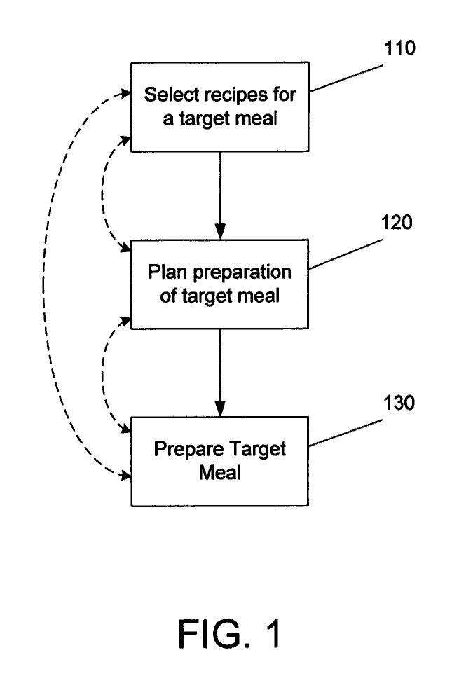

FIG. 1 is a flowchart showing the steps in meal preparation and planning, according to an embodiment herein. Numerous tools and methods may be used in the process. Flow begins at step 110 where the system supports the user in selecting recipes for a target meal. The recipes are stored electronically in a database and accessible to the user via a user interface allowing reading and other access to the recipes and cookbooks stored in the database. The database may differentiate between recipes purchased, acquired, input, given to, or otherwise owned by the user and recipes in an electronic store. The user interface may be a web page based interface. Alternatively, the user interface could be a software program or collection of programs on a computer such as the user's laptop or other personal computer systems. In another embodiment, the user interface could be an application on a device such as an iPad, iPhone, Droid or other computing devices that may also be telecommunication devices. The user interface may take inputs from the user in a variety of forms, depending upon the particular embodiment and the capabilities of the device hosting the user interface. For instance, an embodiment of the user interface based on web pages accessed through the browser of a personal computer may accept keyboard and mouse inputs or inputs from other user input devices that may be connected, wired or wirelessly, to the personal computer such as a rollerball device or devices to assist the handicapped. Alternatively, an embodiment of the user interface as an application on an iPad or iPhone may accept inputs through a touch screen. Inputs could additionally be provided through an automated computer program driven interface, for instance an automated search program or through voice commands. One skilled in the art will appreciate that a variety of input methods are available and the description of the invention with respect to a particular embodiment of the user interface does not limit the intended scope of the invention.

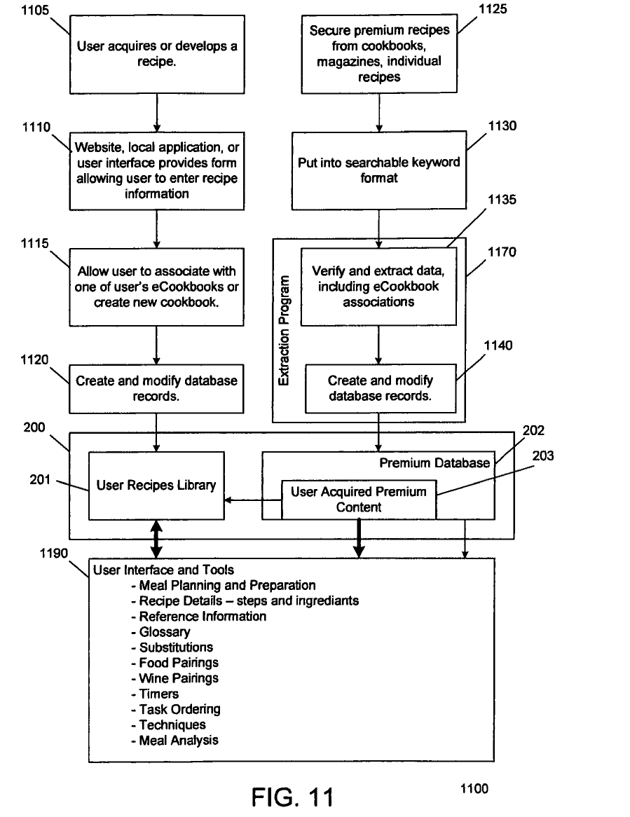

The recipes stored in the database, referred to as eRecipes, comprise a plurality of recipes representing the contents of electronically stored collections or series of eCookbooks, electronically stored individual cookbooks (eCookbooks) or electronically stored individual recipes. The population of the database with eCookbooks and eRecipes will be described below with reference to FIG. 11.

The database can be a secure database stored on a remote server accessible via the Internet or some other communications or data network or combination thereof such as accessing the Internet via a cellular network or a WiFi network. Alternatively, the database can be stored locally on the user's device such as the user's personal computer or iPhone. In another embodiment, the database can be stored both on a remote server and locally, or may be distributed. For instance, the full database may be stored on a remote database while the target meal may be copied to a smaller version of the database on the user's local device, or eRecipes accessed under the terms of a subscription may be stored on a remote server while eRecipes populated into the database by the user may be stored locally on the user's device.

After the recipes have been selected for the target meal, flow proceeds to step 120 as represented by the solid arrow. At step 120, the system supports the user in planning the preparation of the recipes selected for the target meal. This may include actions such as scaling the recipe for a different number of servings, choosing between US and metric measurements, substituting ingredients, determining preparation times, determining needed cooking equipment, determining food parings from multiple cookbooks or series of cookbooks, determining wine pairings, and creating shopping lists. Reference information or information on cooking techniques may be made available to the user. One skilled in the art would recognize that this list is not intended to be exhaustive. Many of these tools, and others described herein, can be used in steps 110 and 130, as well as in step 120.

After the meal preparation has been planned, flow proceeds to step 130 as represented by the solid arrow. At step 130, the system supports the user in the preparation of the recipes selected for the target meal. This support can include displaying the steps or tasks required in the recipe, explaining cooking techniques to the user, suggesting ingredient substitutions, providing timers, suggesting task ordering amongst the collection of recipes, and other features described below. One skilled in the art would appreciate that additional functions may be added without detracting from the scope of the current system and methods.

As can be appreciated, the system may support the user, in the course of planning and preparing a meal, to move back and forth between the steps in the flow of FIG. 1 as represented by the dashed arrows. For instance, while preparing the meal, the user may realize the need for an additional recipe or subrecipe such as a sauce. The system supports the user, providing a means and method for functions such as allowing the user to select the sauce, determine a shopping list of the ingredients for the sauce, forward the ingredients list to a helper's cell phone, while simultaneously supporting the user in the preparation of the other recipes in the meal.

The various actions in method of FIG. 1 may be performed in the order presented, in a different order or simultaneously. Further, in some embodiments, some actions listed in FIG. 1 may be omitted.

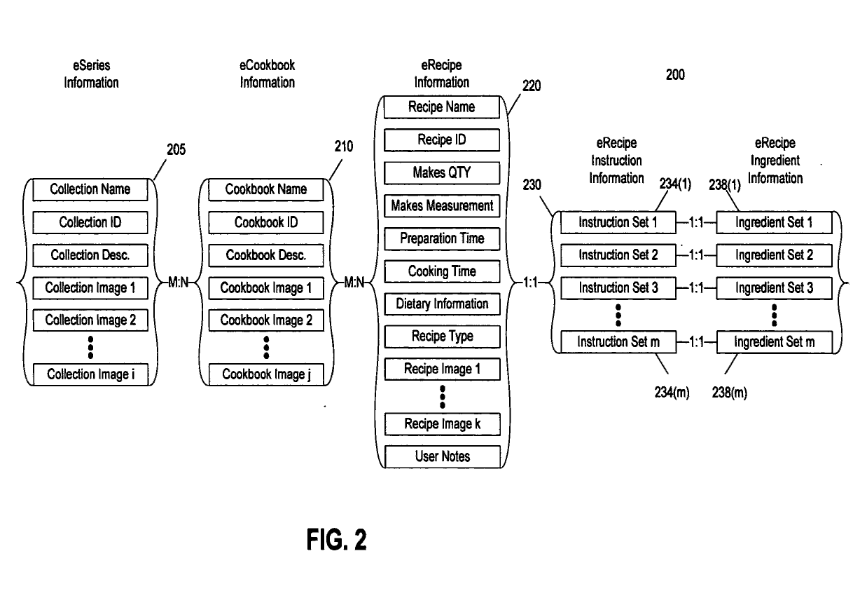

FIG. 2 shows the preferred structure of a database 200 and database records for use in the system and method of the current invention. Recipes are stored in the database in the context of cookbooks, series of cookbooks, or individual recipes. The collection of records and fields comprising the electronic representation of a series of related cookbooks, including the associated cookbooks and recipes, in the database is referred to as an eSeries. The collection of records and fields comprising the electronic representation of a cookbook, including its associated recipes, in the database is referred to as an eCookbook. The collection of records and fields comprising the electronic representation of a recipe, including instructions and ingredients, in the database is referred to as an eRecipe. As will be described, recipes are comprised of one or more subrecipes. eCookbooks may be electronic representations of traditional cookbooks, such as “The Joy of Cooking” or may be a means of collecting and managing individual recipes such as those populated into the database by the user or populated into the database from food manufacturers or distributors, wineries, celebrity or private chefs, caterers, or any other recipe source. They may also be collections of recipes from a particular edition or article within a magazine such as “Food & Wine” or “Good Housekeeping”.

There may be more than one instantiation of a database. For example, one instantiation may represent the eCookbooks and eRecipes available from an online store for purchase or free from food companies. Another instantiation may be an individual user's library of eCookbooks and eRecipes acquired from the online store or entered in from other sources.

Database record 205 is an example of an eSeries Information record with associated fields. One skilled in the art would understand that some or all of these fields may alternatively be implemented as records or subrecords. Some fields may be optional depending on the particular tools or functions of the present invention implemented by a particular embodiment. Other fields not shown may be added such as Publisher. One skilled in the art will appreciate that many of the database fields and many of the functions of the present invention may be included in or left out of an embodiment of the present invention without detracting from the novelty of the present invention. There is a database record 205 for each eSeries in the database.

Database record 205 may be comprised of fields as now described. A Collection Name field identifies the collection to the user. A Collection ID field provides the primary index for identifying the eSeries in the database. A Collection Description field provides a description of the eSeries. In a preferred embodiment the Collection Description may include the use of keywords useful for searching the collection of cookbooks. One or more Collection Image fields may be included in the eSeries Information database record 205. These images may be of anything related to the collection of cookbooks such as the front covers, pictures of the authors or chefs, pictures of the region from which the cuisine originates, and so forth.

Each eSeries Information database record 205 points to or is otherwise related to a plurality of eCookbook Information records 210. However, an eSeries Information record 205 may exist that is not currently associated with any eCookbook Information records 210. Alternatively, eSeries Information database record 205 may contain copies of the Cookbook ID fields from a plurality of eCookbook Information records 210.

Database record 210 is an example of an eCookbook Information record with associated fields. One skilled in the art would understand that some or all of these fields may alternatively be implemented as records or subrecords. Some fields may be optional depending on the particular tools or functions of the present invention implemented by a particular embodiment. One skilled in the art will appreciate that many of the database fields and many of the functions of the present invention may be included in or left out of an embodiment of the present invention without detracting from the novelty of the present invention. Similarly, other database fields may be added. There is a database record 210 for each eCookBook in the database. These may be associated with an eSeries record 205 or independent of any eSeries or collection of cookbooks. In the preferred embodiment, an eCookbook Information record 210 may be a member of or associated with more than one eSeries Information record 205. For example a book of recipes from the south coast of Spain may be in a collection of cookbooks on the cuisine of Spain and simultaneously in a collection of cookbooks on Mediterranean cuisine.

eCookbook Information record 210 may be comprised of fields as now described. A Cookbook Name field provides the name of the cookbook. This may be the actual title of a published cookbook, such as “The Joy of Cooking” or may describe a cooking magazine issue or article or may be a user created name for a collection of recipes populated into the database by the user. A Cookbook ID field provides the primary index for identifying the eCookbook in the database. A Cookbook Description field provides a description of the cookbook. In a preferred embodiment the Cookbook Description may include the use of keywords describing varieties of cuisines such as Italian, classes of dishes such as desserts, names of Chefs, or any of a number of pieces of information which would support searching the database or providing information to the user. One or more Cookbook Image fields may be included in the eCookbook Information database record 210. These images may be of anything related to the cookbook such as the front cover, a picture of the author or chef, a picture of the region from which the cuisine originates, a picture of the most popular dish, and so forth. eCookbook Information record 210 may also contain such additional fields including but not limited to Publisher, Author, Author biography or information, ISBN number, Print Date, Number of Recipes, and Table of Contents.

Each eCookbook Information database record 210 points to or is otherwise related to one or more eRecipe Information records 220. However, an eCookbook Information record 210 may exist that is not currently associated with any eRecipe Information records 220. Alternatively, eCookbook Information database record 210 may contain copies of the Recipe ID fields from one or more eRecipe Information records 220.

An eRecipe Information record 220 is comprised of one or more fields containing information describing or related to the recipe. One skilled in the art would understand that some or all of these fields may alternatively be implemented as records or subrecords. Some fields may be optional and other may be added depending on the particular tools or functions of the present invention implemented by a particular embodiment. One skilled in the art will appreciate that many of the database fields and many of the functions of the present invention may be included in or left out of an embodiment of the present invention without detracting from the novelty of the present invention. There is a database record 220 for each eRecipe in the database. These may be associated with an eCookbook Information record 210 or independent of any eCookbook. In the preferred embodiment, an eRecipe Information record 220 may be a member of or associated with more than one eCookbook Information record 210. For example a recipe for Tiramisu may be in a cookbook of Italian cuisine while simultaneously being in a cookbook of dessert recipes.

eRecipe information record 220 may be comprised of fields as now described. A recipe Name Field identifies the recipe in a meaningful way to the user. A Recipe ID field provides the primary index for identifying the eRecipe in the database. A Makes Quantity field indicates the number of servings or other measure (loaves, pie crusts, etc.) the recipe is designed to create. A Makes Measurement field aids conversion between US and metric units. A Preparation Time field indicates the time (typical, minimum, maximum, etc.) required preparing the recipe prior to cooking. A Cooking Time field indicates the typical time required to cook the recipe. A Dietary Information field contains dietary information such as grams of protein, vitamin content, total calories, etc. A Recipe Type field can be used to categorize recipes as may be done in sections of a cookbook. For instance, recipes may be distinguished as appetizers, desserts, sauces, etc. One or more Recipe Image fields may be included in the eRecipe Information database record 220. These images may be of anything related to the recipe such as a picture of the completed dish or intermediate steps in the recipe process. A User Notes field enables storage of user created notes regarding the recipe. One skilled in the art would recognize that other information such as cooling or setting time, publisher notes, or recipes variants may be included in records in eRecipe Information record 220 or in eRecipe Instruction Information record 234 described below.

Each eRecipe Information database record 220 points to or is otherwise related to one eRecipe Instruction and Ingredient Information record 230. Each eRecipe Instruction and Ingredient Information record 230 is comprised of one or more pairs of fields or records. Each pair of fields is made up of an Instruction set field 234 and an Ingredient Set field 238. In an alternative embodiment, each eRecipe Information database record 220 points to or is otherwise related to one or more eRecipe Instruction Set records 234, each of which point to or are otherwise related to one eRecipe Ingredient Set records 238. Each Instruction set field or record 234 contains the instructions for a portion or sub-recipe or the overall recipe. For instance, Instruction Set 234(1) may contain instructions for the portion of a recipe that must be prepared the night before such as marinating a piece of meat, while Instruction Set 234(2) may be instructions for grilling the piece of meat, while Instruction Sets 234(2) through 234(m) may be alternative sauces, salsas, etc. that are chosen amongst to serve on or with the meat. Each Instruction Set 234 has a corresponding ingredient Set 238 indicating the ingredient used in that portion of recipe or sub-recipe.

FIG. 11 shows the high level process 1100 for populating the database for use by the system and tools. The process varies depending upon whether the source of the recipe is the provider of the system and database and associated services or the source of the recipe is the user of the system and database.

At step 1105 the user procures or develops a recipe. The recipe could be from any source. At step 1110 the system and its associated user interface support the user in entering the recipe. This could be via a form or data entry user interface on a website or in an application on the user's computer or other device such as an iPhone. In a preferred embodiment the interface would allow entry of ingredients, instructions, notes, images, or any other data for which the database supports storing with the recipe. Alternatively, the system could provide a means for extracting the information from a scanned copy of the recipe or for cutting and pasting a recipe from an existing document or web page.

At step 1115 the system and its associated user interface supports the user in associating the recipe with an eCookbook if desired or allows the user to retain the eRecipe without association with an eCookbook. The system and user interface may support the user in associating the recipe with an eCookbook already created by the user or may support the user in the creation of a new eCookbook. Since eRecipes Information records 220 and eCookbook Information records 210 can be accessed directly, one skilled in the art would recognize that the order of creating eCookbooks and creating eRecipes is interchangeable.

At step 1120, the system creates new database records as needed to store the new eRecipe or eCookbook. At this step existing records may also be modified, such as modifying an existing eCookbook Information record 210 to point to a new eRecipe Information record 220. The user's eRecipes are stored in database 200 in a User Recipes Library section 201 containing user generated or user entered recipes. In a preferred embodiment the User Recipes Library 201 resides local to the user's device such as their personal computer, iPad, iPhone, or other properly enable device. The User Recipes Library may be stored such that access via a LAN, the Internet, or some other network is provided for sharing with the user's friends or family or by the user when using an alternate device other than the one on which the data is stored. In an alternative embodiment, the User Recipes Library 201 resides on or is replicated on storage provides by the system provider so the user's recipes may be shared with family or friends via the Internet or some other network.

Once stored, the recipes are available for access, viewing, and interaction through the system's user interface, applications, and tools collectively shown in the box labeled 1190.

Additionally, the above described process may be used to allow the user to modify an eRecipe or eCookbook already stored in the User Recipes Library 201 portion of database 200.

In various embodiments, user may add user defined recipes into the database. User may also tag and organize user defined recipes along with premium recipes from the library.

Additionally, cookbooks and recipes may be populated into the database by the provider of the system, database, and associated tools and services. At step 1125 the system and database provider procures recipes from different sources. This content may come from publishers, chefs, food companies, caterers, special events such as winery dinners, cooking magazines, cooking shows, or any number of sources. This content is referred to as premium content and may be previously tested for quality and repeatability.

The premium content may come in a variety of forms such as Adobe Acrobat .pdf files, InDesign files, or Quark files depending upon its source. In a preferred embodiment at step 1130 the recipes as well as any cookbook or cookbook collection information is put into a searchable form compatible with an extraction program 1170 that may search for keywords to effect turning the cookbooks and recipes into records in the database 200. The searchable form may take many forms such as a manual entry form, a text file, a Microsoft Word document, an Adobe Acrobat document, a Microsoft Excel spreadsheet or some other file format as long as it is compatible with an appropriate extraction program 1170. One skilled in the art would recognize that there may be intermediate forms such as an Adobe Acrobat document created by scanning a hardcopy recipe or cookbook that is then further processed into a keyword searchable Microsoft Excel spreadsheet for processing by an extraction program 1170. There are numerous automated or manual techniques that may be used.

The searchable form of the source material is provided to an extraction program 1170 which performs step 1135 to verify and extract the data including associating recipes with cookbooks. In addition to keyword and text, images may be extracted from cookbook and recipe content. The extraction program 1170 could be implemented as software running on a computer associated with the database storage system which could be an individual computer with built in storage, a bank of computers, or a bank of storage devices. At step 1140, the extraction tool populates the information into the database 200 creating and linking eSeries Information records 205, eCookbook Information records 210, eRecipe Information records 220, eRecipe Instruction Information records 234 and eRecipe Ingredient Information records 238 as necessary. In an alternative embodiment, the output of the extraction program 1170 is provided to another computer program or device which performs the actual modification of database 200.

Reference Information, Tools and Technique information may also be extracted from cookbooks and recipes to be added to the database records for recipes and cookbooks. This information may be additionally added to eRecipe Information records 220 for other recipes with similar ingredients, cooking methods, and preparation requirements. This information may be put into the database and associated with appropriate eRecipes via automated search tools.

The premium content is stored in a Premium Database 202 portion of the database 200. The Premium Database 202 is preferably stored on storage media controlled by the system and database provider and is access via the Internet through a website or a user interface or application running on the user's personal computer, iPad, or other properly enabled device. In a preferred embodiment the Premium Database forms the user acquirable content of an online store. In a preferred embodiment eRecipes in the Premium Database 202 are also acquirable through the methods described in co-pending U.S. patent application Ser. No. 12/370,400 filed Feb. 12, 2009 and entitled “Promotional Electronic Recipe Distribution” which is hereby incorporated by reference. Using the methods described in 12/370,400, the user receives a code through various means such as a magazine, kitchen product, food product, or television. The code is associated with one or more eRecipes in Premium Database 202. The consumer may use the code to acquire the associated recipe or recipes.

Once stored, the recipes are available for access through the system's user interface, applications, and tools collectively shown in the box labeled 1190.

If a user purchases or otherwise acquires access to an eCookbook or eRecipe in the Premium Database 202 it is considered to be part of the User Acquired Premium Content 203 for that user. Each user of the system may have their own User Acquired Premium Content 203. One skilled in the art would recognize that here are many ways that database 200 may store information relating to the particular Premium Content 202 logically contained in or physically copied to User Acquired Premium Content 203.

The system's user interface, applications, and tools, collectively shown in the box labeled 1190, may interact with the database 200 to access eRecipes and eCookbooks while supporting the user in the processes of meal planning, preparation, and execution. In the preferred embodiment, a copy of the eCookbook and eRecipe Information records 210 and 220, respectively, in User Acquired Premium Content 203 may be copied to the same local storage storing the user populated User Recipes Library 201, allowing access even under circumstances where the user does not have connectivity to the Premium Database 202. If the User Acquired Premium Content 203 is local to the user's device, it may be protected from further sharing through a well known or proprietary digital rights management technique. There may be other restrictions such as limited or no remote sharing with family and friends and restrictions or locks on modifying an eRecipe's eCookbook associations. However, substitutions, unit conversion, scaling, and user notes may be allowed modification to locally stored eRecipe Information Records 220 from the User Acquired Premium Content 203.

In an alternative embodiment, the User Recipes Library 201 contains only user populated eRecipes and the system interacts with the Premium Database 202 to access the User Acquired Premium Content 203. Stored substitutions, unit conversion, scaling, and user notes for the acquired premium eRecipes are stored in the User Recipes Library 201 in special records associating or linking them to the eRecipe Information Records 220 in the Premium Database 203.

One skilled in the art would recognize that process 1100 may be followed at any time new material is available for use in the system and database.

One skilled in the art would recognize that additional information such as glossary terms, wine pairing relationships, food pairing relationships, nutritional information and so forth may be populated into the system or database through similar means or may be access from separate databases or systems.

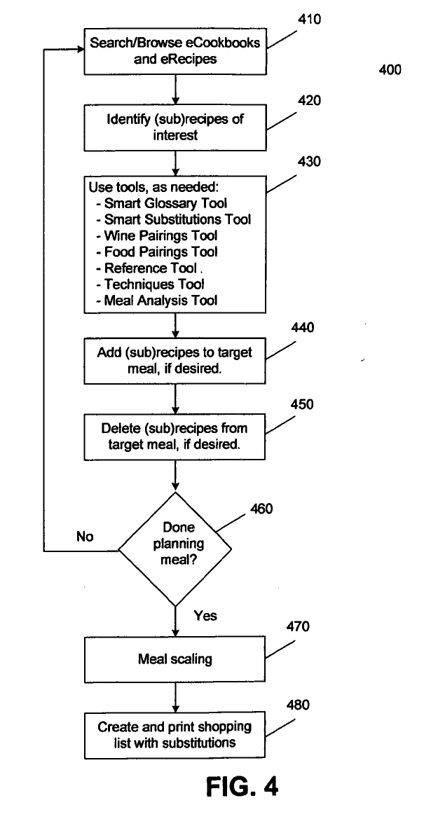

The process of meal planning is described with respect to FIG. 4. The system and method of the present invention supports the user planning one or more than one meal at a time. The user may associate a name with a target meal. For instance, a user may plan “tonight's meal” while also planning “Thanksgiving Dinner”. The process 400 for planning a particular meal begins at step 410 where the user searches or browses for recipes of interest. The system, database and methods of the current invention support the user browsing the collection of eCookbooks in the user's library database. For example, the user may be presented with a user interface showing eCookbook covers, titles, or other information. The user may be provided with tools to browse the table of contents of the eCookbooks. While browsing an eCookbook, the user may be provided with the capability to browse the table of contents or recipes contained in the eCookbook. Similarly, the user may be able to browse eCookbooks in an online store, where the user has an opportunity to purchase an eCookbook or individual eRecipe of interest. As an alternative to browsing eCookbooks, the user may be provided with an interface allowing browsing eRecipes directly, both in the user's library database or an online store.

In a preferred embodiment the system, database, and methods also allow the user to search both eCookbooks and eRecipes. Searching can be done on any number or combination of keywords or concepts. For instance, a user may search for barbeque recipes, or recipes for cooking chicken, or the combination of recipes for barbequing chicken. Searches may be performed by chef, style of cuisine (e.g. Italian), or recipe type (e.g. main course). Searching may be performed based on specific eRecipe Information record 220 fields, such as Recipe Type, or on keywords embedded in fields such as Recipe Description. Searching may be performed on concepts as diverse as ingredients and wine pairings, e.g. find a recipe for white fish that goes with a Sauvignon Blanc wine. As with browsing, searching may also search eCookbooks and eRecipes in an online store where the user has an opportunity to purchase the discovered eCookbook or eRecipe.

Further, in an embodiment, the system includes various modules to achieve the methods of embodiments herein. The various modules include a first module for aggregating series, cookbook and recipe information from various sources. The first module includes a sub module for accessing content from the sources and a conversion tool to convert the content to a structured format, preferably predefined unit system. The system further includes a second module for adding the aggregated series, cookbook and recipe information in the database. Further, a third module for providing access to the information stored in the database is also provided in the system. The system further includes a tagging module, a navigation module, a comparison module and a presenting module. The tagging module facilitates tagging of a recipe at least during the process of preparing target meal. The navigation module enables the user to navigate between series, cookbooks and recipes in a non-linear manner. The comparison module compares recipes across series and cookbooks. Further, the presenting module provides for presenting options for the recipes selected by the user. It is also within the scope of the invention to use the system with the aforementioned modules in various embodiments as described herein without otherwise deterring the intended function of such embodiments.

At step 420, the user identifies a recipe of interest. The system may provide for tagging or some means to identify and keep track of recipes of interest prior to final inclusion in a target meal. Identifying the recipes of interest for a particular meal allows the system and user interface to organize or present the meal as a menu. The menu may be separated into courses based on such eRecipe Information record 220 fields as Recipe Type. Further, the user system, user interface, and tools may support the user in ordering the eRecipes in the meal or menu such as may be done with a music playlist for an iPod or MP3 music player.

A variety of tools are available to the user. As indicated by step 430, the user may use one or more of these tools while selecting recipes for the target meal. The tools may operate on individual recipes or sets of recipes in the identified recipes of interest, the recipes included in the target meal or a combination. For instance a Smart Glossary tool may allow the user to look up a term or ingredient definition or description. A Smart Substitutions tool may allow the user to identify a substitute of an ingredient. A wine pairings tool may suggest wines to go with recipes or recipes to go with a particular wine. A food pairings too may suggest recipes that can be complimentary, even if from different cookbooks. For instance, the food pairings tool may suggest an appetizer recipe from a Mexican cuisine cookbook to be paired with a main course from a Spanish cuisine cookbook. Reference tools and Techniques tools may extract information from the eCookbook or eRecipe or from a more encyclopedic database of information. Meal Analysis tools may be available to analyze dietary content of a recipe or meal, provide allergy warnings, total preparation and cooking time for a meal based on available resources, e.g. one oven or two, and the like.

At step 440, the system and database provide the user with the ability to tag a recipe or sub-recipe as being part of the target meal. This allows the user to easily go back and forth between recipes in the target meal in a non-sequential fashion during preparation, planning and execution while simultaneously allowing generation of a menu ordered by courses or ordered as chosen by the user. Similarly, at step 450, the system and database provide the user with the ability to remove a recipe or sub-recipe from the target meal. At step 460, if the user wishes to continue planning the system allows return to step 410 to further browse and search for recipes of interest. One skilled in the art would appreciate that the system and database allow steps 410 through 450 to be performed in many different orders, iteratively, passing back and forth between the different steps, and skipping steps as desired.

When the user is finished planning a meal, the system and database support the scaling of a meal. For instance the number of servings may be changed or the units may be converted from US to metric. These changes may be in the form of simple scaling of ingredients, e.g. cut quantities in half for half the number of portions, or may be more complex as in the case with baking where temperatures, dish sizes, and cooking times may also need to be scaled. Substitution of ingredients may also be taken into account in the scaling process. The system and database support the storing of the meal at any point in the process. Planning of a meal can start from a previously stored meal as well as planning a meal from scratch. Tentative menus can be created and modified at any point in the process.

Flow then continues to step 480 where the system and database supports the creation and printing of a shopping list. Alternatively, the shopping list may be emailed, texted or otherwise sent to a device such as a cell phone. The shopping list created takes into account scaling and substitutions and may be modified based on ingredients already possessed by the user. The system and tools also allow the user to modify the shopping list by adding additional ingredients and removing individual ingredients. The user is allowed add shopping notes. Ingredients on the shopping list may be categorized according to where they exist in the store e.g. aisle or section such as Dairy, frozen foods, or meats.

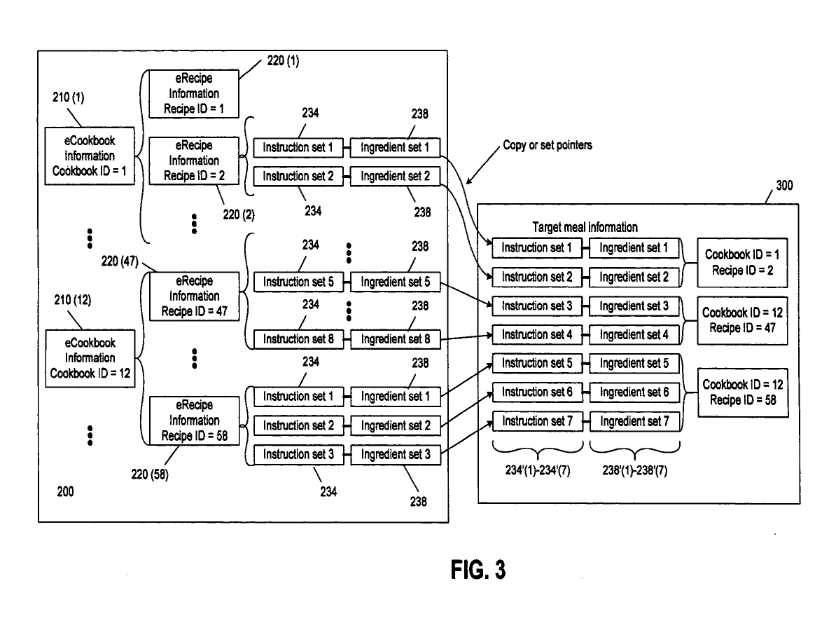

FIG. 3 shows an embodiment of the database supporting the creation of a target meal 300. In the process of steps 410 through 460 of FIG. 4 the user identifies and selects recipes or subrecipes for the target meal. For instance, the user may identify and select a recipe with recipe ID=2 in eRecipe Information record 220(2) from a cookbook with Cookbook ID=1 in eCookbook Information record 210(1) and two recipes with recipe IDs=47 and 58 in eRecipe Information records 220(47) and 220(58), respectively from a cookbook with Cookbook ID=12 in eCookbook Information record 212(12). In this example, the eCookbooks are not shown as part of a collection represented by an eSeries Information record 205, but one skilled in the art would understand that they could be either part of a collection defined by an eSeries Information record 205 or they may be standalone.

In this example, the recipe contained in eRecipe information record 220(2) comprises two eRecipe Instruction Information records 234 with their respective eRecipe Ingredient Information records 238. Similarly, the recipe contained in eRecipe information record 220(47) comprises eight eRecipe Instruction Information records 234 with their respective eRecipe Ingredient Information records 238, and the recipe contained in eRecipe information record 220(58) comprises three eRecipe Instruction Information records 234 with their respective eRecipe Ingredient Information records 238. Further, in this example, all Instruction Set 234-Ingredient Set 238 pairs of eRecipe Information records 220(2) and 220(58) are included in the target meal, but only two of the Instruction Set 234-Ingredient Set 238 pairs, representing two sub-recipes, have been selected from eRecipe Information record 220(58).

In this example target meal 300 then contains Instruction Sets 234′(1)-234′ (7) and their associated Ingredient Sets 238′(1)-238′(7). One skilled in the art would appreciate that these could be contained in target meal 300 by copying the database information or by pointers or other indexes. To allow indexing between selected recipes and sub recipes in the target meal and the original records in the database, the respective Cookbook IDs and Recipe IDs may be associated with the Instruction Sets 234′ (1)-234′ (7) and their associated Ingredient Sets 238′ (1)-238′ (7). Alternatively, the target meal 300 may contain copies of or pointers to entire eRecipe Information records 220. This can facilitate the use of tools and the location and display of information while planning and preparing the target meal.

The various actions in method of FIG. 4 may be performed in the order presented, in a different order or simultaneously. Further, in some embodiments, some actions listed in FIG. 4 may be omitted.

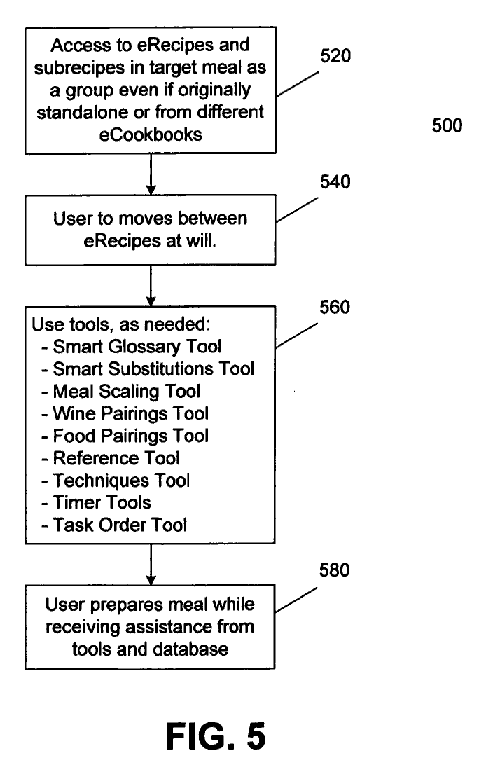

FIG. 5 shows the flow for preparing a meal using the present invention. At 520 the system and database supports the user in accessing a previously stored target meal 300. All Collections, eCookbooks and eRecipes associated with the target meal 300 may be viewed in a variety of formats or views depending upon the user interface and the device used. Views may include listings (one, two, or more columns), thumbnail images, etc.

As previously described, this target meal 300 is comprised of pairs of Instruction Sets and Ingredient Sets representing various eRecipes or sub-recipes.

The contents of the target meal 300 may contain substitutions and scaling performed in the meal planning process described previously. The eRecipes may be standalone or from eCookbooks, which may be standalone or from eSeries. To facilitate the activity of the various tools available to the user, the Instruction Sets and Ingredient Sets are associated with or otherwise linked to at least the Recipe ID field of the eRecipe Information record 220 for their parent recipe. Similarly the Cookbook IDs and Collection IDs associate or otherwise link back to the parent eCookbook Information record 210 and eSeries Information record 205, if available.

Since the preparation of a meal may require the user to interleave the steps of one recipe with steps of another to ensure proper timing of the readiness of the meal as a whole, the system and database allow the user to move between recipes at will as shown in step 540, keeping track of the current state of each individual recipe in the current meal.

While moving between recipes in the target meal, the system and database provide tools for the user to aid in the predictable preparation of the meal in steps 560 and 580. Some tools available while preparing a meal were also available while planning a meal as previously described. One skilled in the art can appreciate that meal planning and preparation can be an iterative process moving back and forth between steps as shown by the dashed arrows in FIG. 1. The user may again use the Smart Glossary tool to double check the meaning of a term or to learn the meaning of a term skipped over during meal planning. The Smart Substitutions tool and Meal Scaling tool may be used to perform changes to the meal while in the preparation stage. The Wine Parings tool and Food Pairings tool can be consulted, possibly resulting in a revision of the meal where a new recipe is added to the meal or one is removed from the meal. A Reference tool allows information to be extracted from the recipe, cookbook, or collection information as may be useful to or of interest to the user. The Techniques tool can aid in properly applying a cooking technique such a “sautéing” by providing text, pictures, video, or other information.

Some tools may be more particular to the preparation process. For instance timer tools may allow the user to set a plurality of timers, each with a purpose directed towards some step of one of the recipes in the target meal. In addition to the traditional timer functions of being set, displaying time remaining, and indication timer expiration, the timers may give an indication of which step they are monitoring. For instance, the Timer tool may allow the labeling of a timer for its current purpose, such as “boil pasta timer” which may audibly indicate that it has expired using a variety of means including a visible our audible phrase such as “take pasta off burner”.

All the while the user is preparing the meal in step 580, the user may use tools in step 560 and move back and forth between meal preparation and meal planning.

The various actions in method of FIG. 5 may be performed in the order presented, in a different order or simultaneously. Further, in some embodiments, some actions listed in FIG. 5 may be omitted.

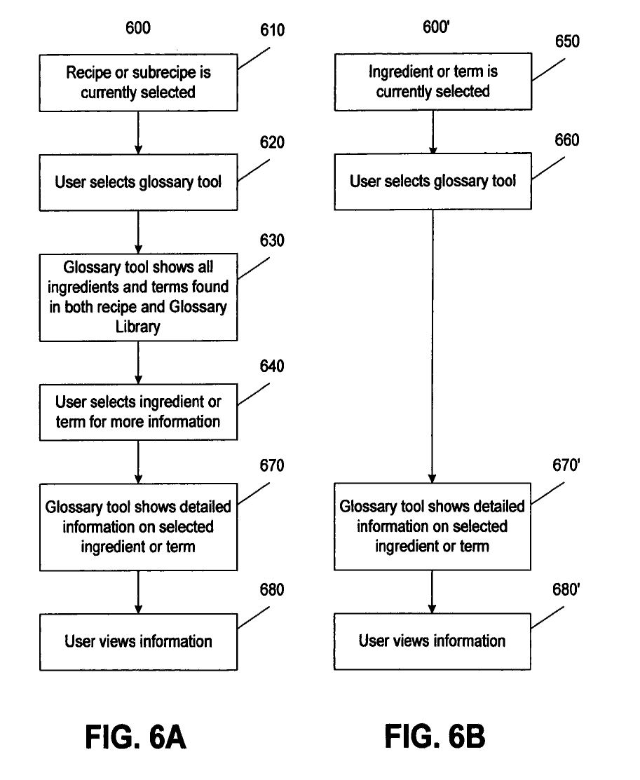

FIG. 6A shows the flow for using the Smart Glossary tool. At step 610, the system and database support the user in selecting a recipe or sub-recipe. This may be during the meal planning process, the meal preparation process or when merely browsing recipes for general interest. With a recipe or sub-recipe selected, the system and database allow the user to select the Smart Glossary tool in step 620. In this situation, the Smart Glossary tool at step 630 accesses the eRecipe Information record 220 and associated Instruction Sets 234 and Ingredient Sets 238 and shows all ingredients and terms in the recipe or sub-recipe for which there is also additional information in the glossary database. At step 640 the Smart Glossary tool allows the user to select a particular ingredient or term for more information. At step 670, the Smart Glossary tool shows detailed information, including pictures and video if available, for the selected ingredient or term, supporting the user reading, listening to, or viewing the information regarding the chosen ingredient.

The various actions in method of FIG. 6A may be performed in the order presented, in a different order or simultaneously. Further, in some embodiments, some actions listed in FIG. 6A may be omitted.

FIG. 6B shows an alternative method for allowing the user to access information through the Smart Glossary tool. In alternative embodiments the system and database allow the user to highlight or otherwise directly select an ingredient or term in step 650 rather than selecting the entire recipe or a sub-recipe as in step 610 of FIG. 6A. In this case when the user selects the Smart Glossary tool in step 660, the Smart Glossary tool proceeds to step 670′ where it shows detailed information, including pictures and video if available, for the selected ingredient or term, supporting the user reading, listening to, or viewing the information regarding the chosen ingredient or term. One skilled in the art would appreciate that the selection of the ingredient or term in step 650 and the selection of the Smart Glossary tool in step 660 could be separate actions supported by the system or could be a single action such as right clicking the ingredient or term.

One skilled in the art would appreciate that the same system, database, and Smart Glossary tool could support both the usage scenario in FIG. 6A and the usage scenario in FIG. 6B.

The various actions in methods of FIG. 6B may be performed in the order presented, in a different order or simultaneously. Further, in some embodiments, some actions listed in FIG. 6B may be omitted.

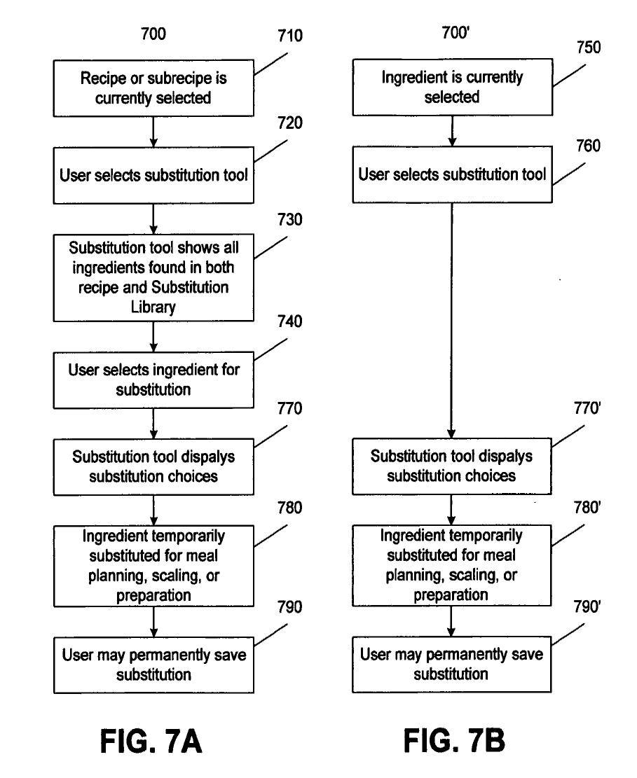

FIG. 7A shows the flow for using the Smart Substitution tool. At step 710, the system and database support the user in selecting a recipe or sub-recipe.

This may be during the meal planning process, the meal preparation process or when merely browsing recipes for general interest. With a recipe or sub-recipe selected, the system and database allow the user to select the Smart Substitution tool in step 720. In this situation, the Smart Substitution tool at step 730 accesses the eRecipe Information record 220 and associated Instruction Sets 234 and Ingredient Sets 238 and shows all ingredients in the recipe or sub-recipe for which there is a substitution in the substitution database. At step 740 the Smart Substitution tool allows the user to select a particular ingredient for substitution. At step 770, the Smart Substitution tool shows substitution choices along with detailed information, including pictures and video if available, for the selected ingredient. At step 780 the Smart Substitution tool allows the user to temporarily substitute the new ingredient for the old ingredient for use in meal planning, scaling or preparation.

The substitution may be one for one such as 500 grams of beef substituted with 500 grams of bison. In other cases a substitution may require a substitution ratio causing the Smart Substitution tool to calculate the new quantity for the substituted ingredient. This substitution amount calculation would be based on the original ingredient and measurement and then calculated and scaled appropriately for the new ingredient.

The substitution can also be made available to other tools such as the Wine Pairing tool or the Food Pairing tool. In the preferred embodiment, in step 790 the Smart Substitution tool can modify the recipe in the User Recipe Library 201 or the User Acquired Premium Content 203, making the substitution permanent for that user without affecting the recipe in the online store or main database.

The various actions in method of FIG. 7A may be performed in the order presented, in a different order or simultaneously. Further, in some embodiments, some actions listed in FIG. 7A may be omitted.

FIG. 7B shows an alternative method for allowing the user to substitute ingredients through the Smart Substitution tool. In alternative embodiments the system and database allow the user to highlight or otherwise directly select an ingredient in step 750 rather than selecting the entire recipe or a sub-recipe as in step 710 of FIG. 7A. In this case when the user selects the Smart Substitution tool in step 760, the Smart Substitution tool proceeds to step 770′ where it shows substitution choices and detailed information, including pictures and video if available, for the selected ingredient. In step 780′ the Smart Substitution tool allows the user to temporarily substitute the new ingredient for the old ingredient for use in meal planning, scaling or preparation as in step 780 of FIG. 7A. In the preferred embodiment, in step 790′ the Smart Substitution tool can modify the recipe in the User Recipe Library 201 or the User Acquired Premium Content 203, making the substitution permanent for that user without affecting the recipe in the online store or main database. One skilled in the art would appreciate that the selection of the ingredient or term in step 750 and the selection of the Smart Substitution tool in step 760 could be separate actions supported by the system or could be a single action such as right clicking the ingredient.

One skilled in the art would appreciate that the same system, database, and Smart Substitution tool could support both the usage scenario in FIG. 7A and the usage scenario in FIG. 7B.

The various actions in method of FIG. 7B may be performed in the order presented, in a different order or simultaneously. Further, in some embodiments, some actions listed in FIG. 7B may be omitted.

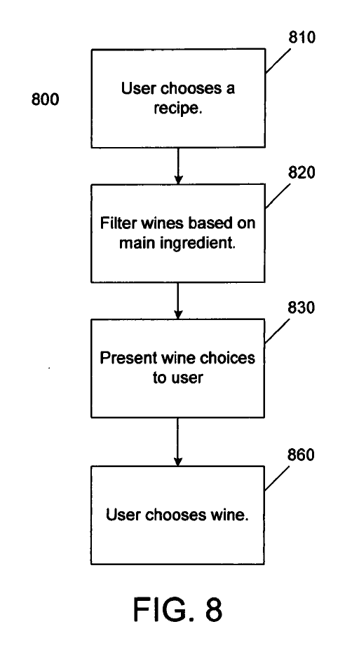

FIG. 8 illustrates the process for using the system to choose wine to go along with a food choice. At step 810, the system supports the user in selecting a recipe from database 200. In a preferred embodiment this is a recipe from the User Recipe Library 201 or the User Acquired Premium Content 203. In an alternate embodiment, this could be an as yet not acquired recipe in the Premium Database 202. At step 820, a wine pairings tool filters the wine choices based upon the primary attribute of the recipe, such as the main ingredient. For instance, if the recipe is a chicken dish certain red wines and all desert wines may be excluded from the results. The algorithm looks at the main ingredient and any modifiers (Cooking method, sauces, spices) and then provides a list of standard or base wine pairings, experimental wine pairings, and best wine pairings.

At step 830, the wine pairing suggestions are presented to the user. In the preferred embodiment the wine pairing tool provides multiple levels of detail to help the user decide on a wine. For instance, the wine pairings tool may indicate a particular varietal such as chardonnay or a blend of a varietal. It may further suggest a wine region. The wine pairing tool may be restricted to suggest standard or base wine pairings or may also suggest experimental pairings of new, less well known or exotic wines. The wine parings tool may indicate that a particular wine or varietal/region combination is not only a good pairing, but the best pairing. For instance, if a certain chardonnay specific to a given region such as the Marlborough region of New Zealand is known as the best for a particular salsa then the Wine Pairings tool may look deeper into the ingredients to see that the recipes has a salsa and then recommend a locally available Marlborough region chardonnay such as Cloudy Bay.

If the user has entered information regarding wines in a personal wine cellar portion of the database or storage accessible by the wine pairing tool, the wine pairings tool may make or be restricted to make pairings from the personal wine cellar.

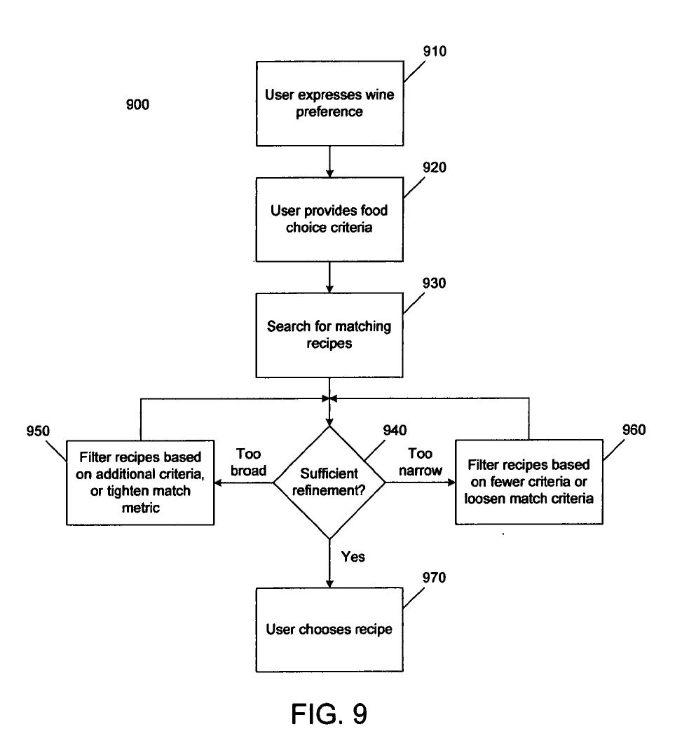

FIG. 9 illustrates the process of choosing a recipe to go with a wine choice. At step 910 the system accepts wine choice inputs from the user. In a preferred embodiment, the wine choice may be expressed in varying detail. The user may chose a wine type such as red, white, or dessert. Additionally, the user may choose a varietal such as merlot or chardonnay. The user may chose a country, wine region, or appellation. One skilled in the art would appreciate that any level of detail may be added if available. Additionally, the user may be provided the ability to select a wine from a personal cellar.

Once the wine choice input have been made, the Wine Pairings tool provides the user with a number of food choices such as beef, seafood, cheese, salads, desserts, etc. At step 920 the user may provide further refined food choice criteria such as choosing garden salads or Greek salads from the salads category. The user then picks their choice.

At step 930, based on the food choice criteria selected at step 920 and the wine preferences selected at step 910, the system searches for matching recipes and presents them to the user. In a preferred embodiment, the search is not restricted to the User Recipes Library 201 and the User Acquired Premium Content 203 and may be allowed to additionally search not yet acquired recipes in the Premium Database 202 portion of database 200. The found recipes may be further ranked by quality of match for instance on a scale of one to ten. There may be a default quality match filter applied. For instance only recipes with a quality match of 7 or better may be displayed to the user. One skilled in the art can understand how such a match quality rating could also be applied in the search for a wine described in FIG. 8.

At decision point 940, the system accepts indication from the user regarding the sufficiency of the search. If the resulting recipe suggestion list is too large, the criteria are considered too broad and may be narrowed. In this case flow proceeds to step 950 where the system assists the user in adding additional filtering criteria or increasing the required match quality number. If at decision point 940 the resulting recipe suggestion list is too small and contains no recipes acceptable to the user, the criteria are considered too narrow and may be broadened. In this case flow proceeds to step 960 where the system assists the user in removing filtering criteria or decreasing the required match quality number.

The process iterates until at decision point 940 the user identifies an acceptable recipe. Flow then proceeds to step 970 where the user chooses the recipe. At this point, if the recipe is a not yet acquired recipe in Premium Database 202, the user is assisted in acquiring the recipe. If the recipe already existed in the User Recipes Library 201 or the User Acquired Premium Content 203 or after the user acquires the recipe from the Premium Database 202, the user can take any number of steps including adding the recipe to a target meal or preparing the recipe.

One skilled in the art would recognize that steps 940, 950, and 960 may be omitted and flow may alternatively proceed directly from step 930 to step 970.

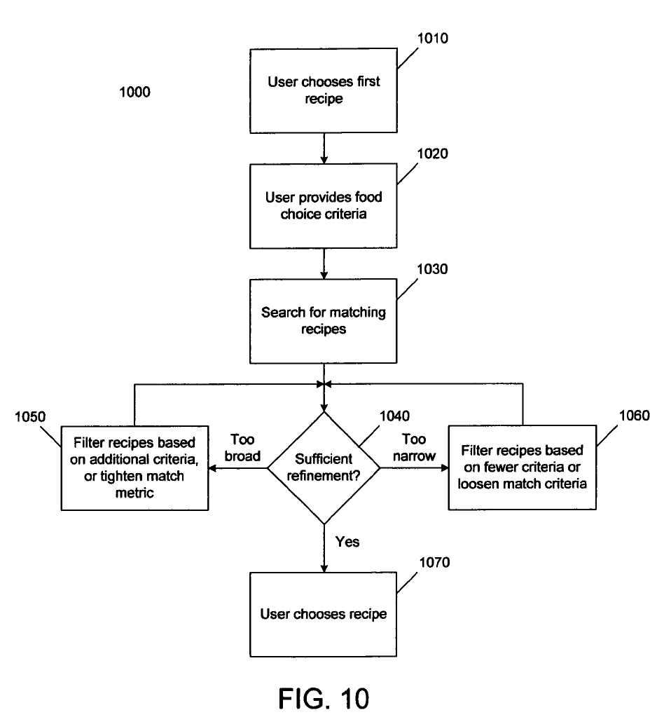

FIG. 10 illustrates the process of choosing a recipe to go with a previously chosen recipe. At step 1010 the system allows the user to choose a recipe. In a preferred embodiment, the recipe choice is from the User Recipe Library 201 or the User Acquired Premium Content 203. However, the user could use the food pairing tool to search not yet acquired recipes from the Premium Database 202.

At step 1020 the food pairings tool provides the user with the ability to set initial food choice criteria for recipes to pair with the previously chosen recipe such as restricting the search to only side dish recipes or only recipes using lamb. It should be appreciated that at step 1020 the user may set any number of food choice criteria including none. At step 1030, based on the food choice criteria selected at step 1020 and the initial recipe selected at step 1010, the system searches for matching recipes and presents them to the user. In a preferred embodiment, the search is not restricted to the User Recipes Library 201 and the User Acquired Premium Content 203 and may be allowed to additionally search not yet acquired recipes in the Premium Database 202 portion of database 200. The found recipes may be further ranked by quality of match for instance on a scale of one to ten. There may be a default quality match filter applied. For instance only recipes with a quality match of 7 or better may be displayed to the user.

At decision point 1040, the system accepts indication from the user regarding the sufficiency of the search. If the resulting recipe suggestion list is too large, the criteria are considered too broad and must be tightened. In this case flow proceeds to step 1050 where the system assists the user in adding additional filtering criteria or increasing the required match quality number. If at decision point 1040 the resulting recipe suggestion list is too small and contains no recipes acceptable to the user, the criteria are considered too narrow and must be loosened. In this case flow proceeds to step 1060 where the system assists the user in removing filtering criteria or decreasing the required match quality number.

The process iterates until at decision point 1040 the user identifies an acceptable recipe. Flow then proceeds to step 1070 where the user chooses the recipe. At this point, if the recipe is a not yet acquired recipe in Premium Database 202, the user is assisted in acquiring the recipe. If the recipe already existed in the User Recipes Library 201 or the User Acquired Premium Content 203 or after the user acquires the recipe from the Premium Database 202, the user can take any number of steps including adding the recipe to a target meal or preparing the recipe.

One skilled in the art would recognize that steps 1040, 1050, and 1060 may be omitted and flow may alternatively proceed directly from step 1030 to step 1070.

### Example Implementation

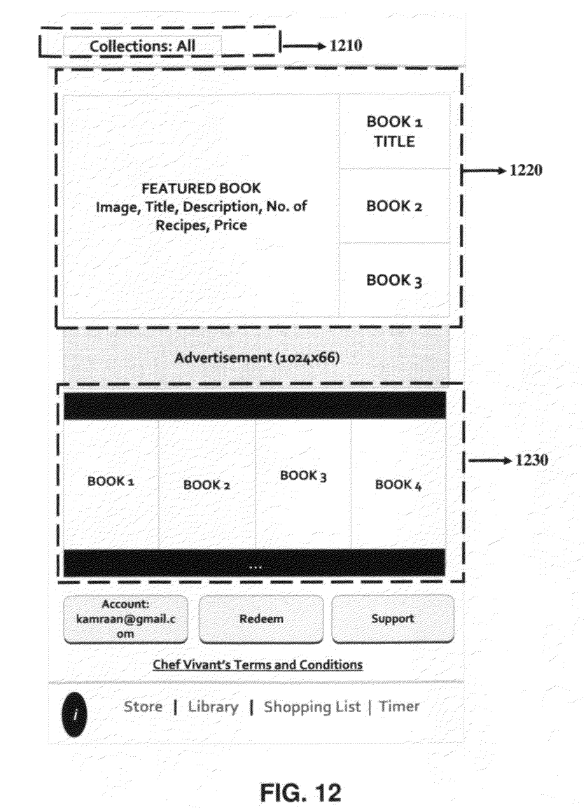

FIGS. 12 to 20 show a user interface on a user device in an example implementation of various embodiments disclosed herein.

FIG. 12 shows the eStore where the user can browse and purchase books from various series of cookbooks. Accordingly, in various embodiments, a user can switch between series as shown in block 1210, browse individual books within a series as shown in block 1220, and pick an individual book from those available to the user as shown in block 1230.

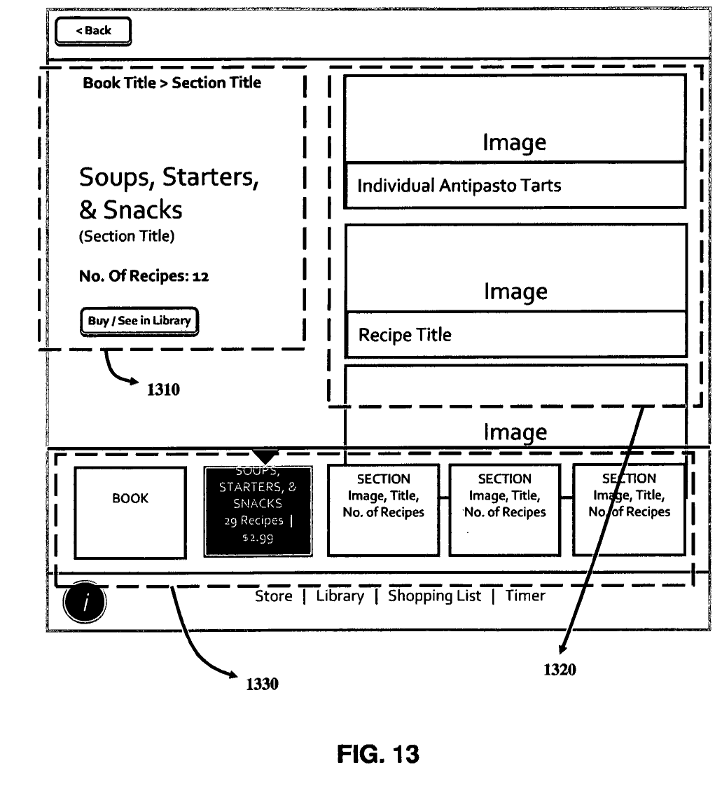

FIG. 13 shows a book detail view where a user can browse through the various sections of a book and the recipes available in book.

Block 1310 highlights the basic details of the sections of the book including the title of the book, the section name, the number of recipes purchased by the user that are part of the section of the book, and a link to buy the recipes contained in the section of the book as a whole or specific recipes online A user may buy a book, a section of recipes, or specific recipes using existing credits or by using direct payment methods including bank transfer, credit cards and so on. Further, if a book is not already bought by the user, the user may use buy/see in library tab to browse through a book. Credits may be purchased at any time using bank transfer, credit cards and so on.

Block 1320 of the figure allows a user to browse through the various sections of purchasable recipes by the user in the book. User may choose to browse through all purchasable recipes in the book or restrict the recipes to a particular section in the book. User may choose a specific section to restrict the recipes visible in block 1320.

Block 1330 shows the various sections available in the book for the user to be able to select and restrict the recipes that he can browse in block 1320.

Further, in some embodiments, a book summary view where a user can browse summary of a book is also made available. In the book summary view, features such as basic details of the book including the title of the book, a summary of the book, book author, book publisher, the book ISBN number, the number of recipes which can be purchased by the user that are part of the book, and a link to buy the book as a whole or specific recipes online are provided among others. Further, a user may buy a book or sections of recipes, or specific recipes using existing credits or by using direct payment methods including bank transfer, credit cards and so on. Credits may be purchased at any time using bank transfer, credit cards and so on.

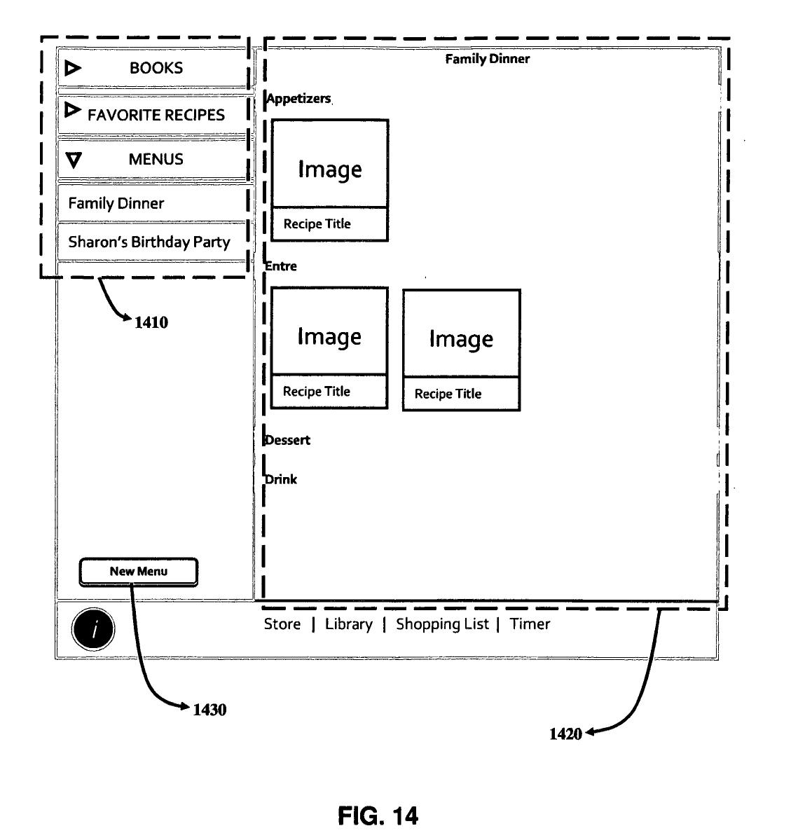

FIG. 14 shows the User Recipe Library information view where entire User's Recipe Library of cookbooks, and recipes of interest for the user is organized into various sections, including Books, Favorite Recipes, and Menus, as highlighted in block 1410.

User may browse recipe information by way of browsing through the various books from which the user owns recipes. User may also browse through recipes that he has marked as favorite recipes. User may also create his own menus for organizing various recipes under different user-defined heads.

FIG. 14 highlights where a user has chosen to view a menu.

Block 1420 highlights the portion of the screen where the user can view the recipes organized under pre-defined categorization heads. Such categorizations of recipe information into different sections of a meal help a user to plan and prepare meal in a planned and efficient manner.

User can also create additional menus as highlighted by block 1410 using a suitable navigation means 1430 like a link or a button.

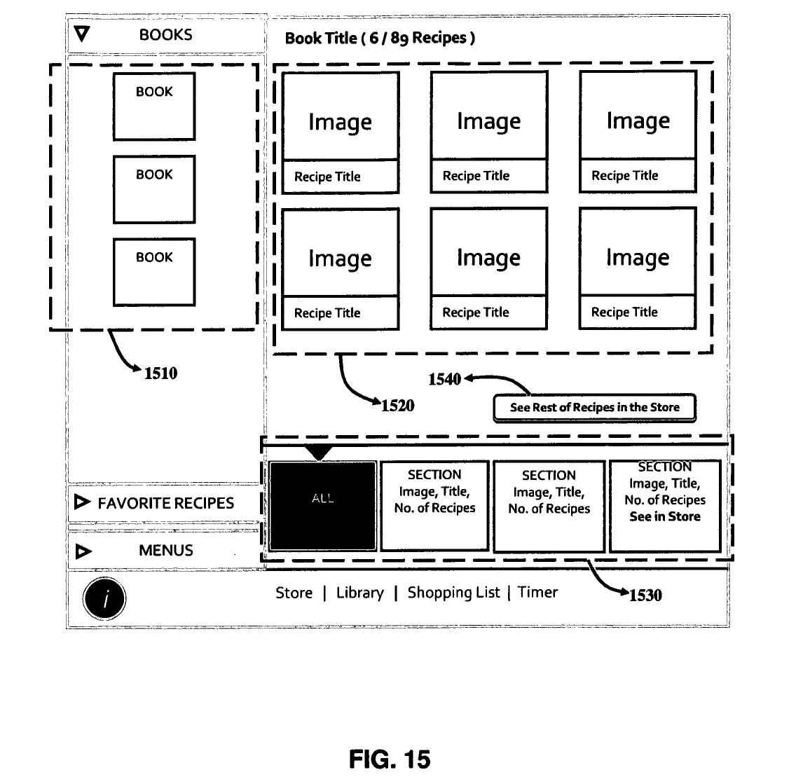

FIG. 15 shows a view for organization of recipe information in books. User can browse through various books from which user has acquired recipes of interest. Upon selecting a book in block 1510, the various recipes available to the user are displayed in block 1520. The user can also filter the recipes that he can view for a book by selecting the relevant section of book in block 1530.

If the user chooses to do so, he may click on the navigation means 1540 to navigate to the store to view other recipes that are part of the book for preview and purchase.

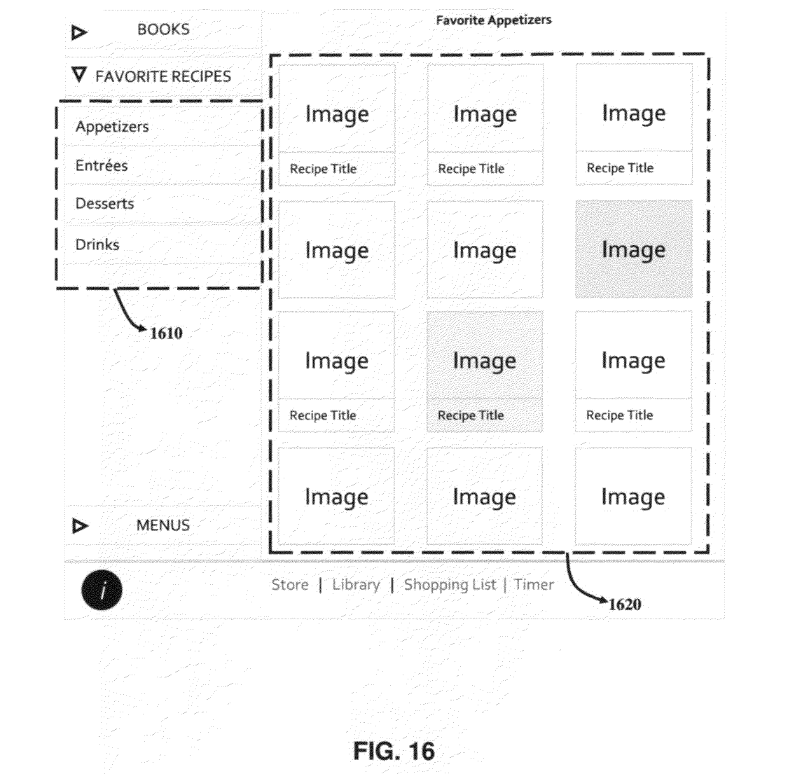

FIG. 16 shows a view for organization of recipe information in the form of favorite recipes. In accordance with the various embodiments, the recipes may be pre-tagged, or the user may choose to tag various recipes including both premium content recipes and user entered recipes as favorite recipes. All such tagged favorite recipes are available for access at a single place under the “favorite recipes” section as highlighted by block 1610. The favorite recipes are automatically classified based on the type of recipe. In an example implementation as illustrated, the recipes may be pre-classified under different heads of a meal, namely, appetizers, entrees, desserts, and drinks. User may browse through the various favorite recipes by selecting on of the classifications in block 1610.

User may browse through favorite recipes under a classification in favorite recipes in block 1620. User may also select one or more recipes for adding to an existing menu or a new menu and so on. Such actions may be performed by dragging and dropping objects using gestures like touch or by dragging objects using a peripheral device means like a mouse. The actual way of manipulating objects depends on the kind of device that is used to access the system.

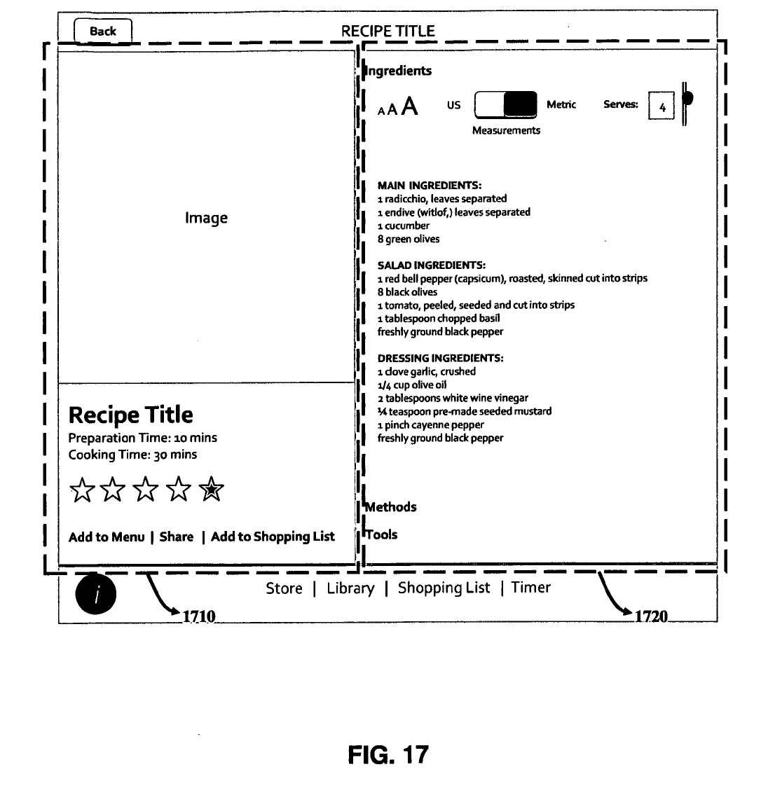

FIG. 17 shows a recipe detail view. A user may arrive at this screen upon selecting a recipe to view the details.

As highlighted by block 1710, recipe detail view presents basic information on the selected recipe including but not limited to image of the recipe, title, rating of the recipe, and other useful navigation means.

User may access recipe information as highlighted by block 1720. A single recipe information is further organized under different segments, namely, ingredients, methods of preparation and tools necessary to work on the recipe. The ingredients segment lists the various ingredients that are part of the recipe, and quantities and proportions for the ingredients. User may also specify the number of servings that he is planning for. Based on user's input on number of servings, the system automatically adjusts the quantities of the ingredients. Use can also switch between US and metric system based on his convenience.

The user may also rate the recipe using the stars in the highlighted block 1710.

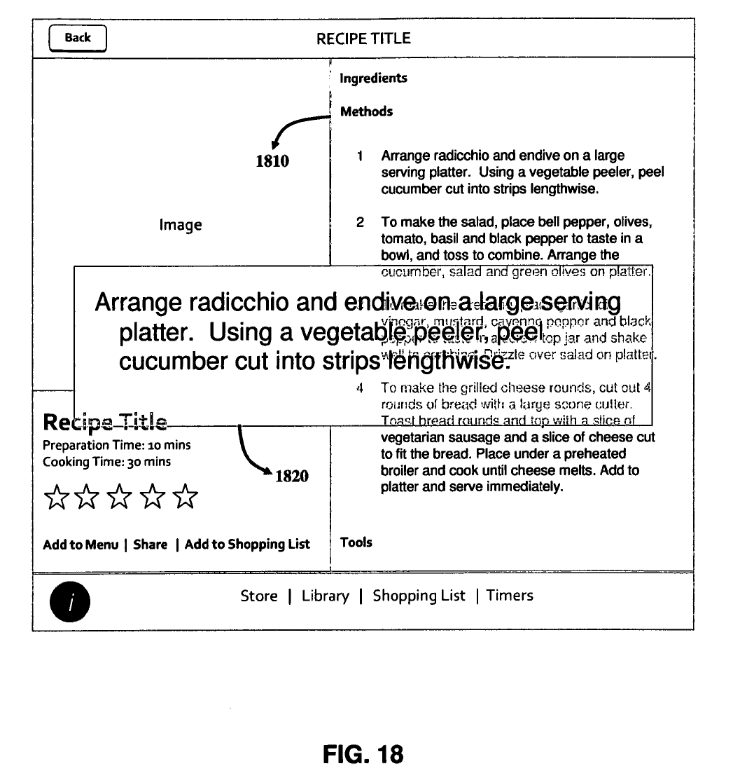

FIG. 18 shows methods segment of a recipe detail view. User may view the methods of preparation of the selected recipe by selecting the “Methods” segment 1810 on the recipe detail view. The methods segment 1810 lists various steps involved in preparation of the recipe meal. User can also highlight a particular step(s) by selecting one or more steps from the methods segment 1810. Upon selecting step(s) for highlighting, a bigger version of the step(s) is displayed as highlighted by the block 1820 to aid the user for easy reading.

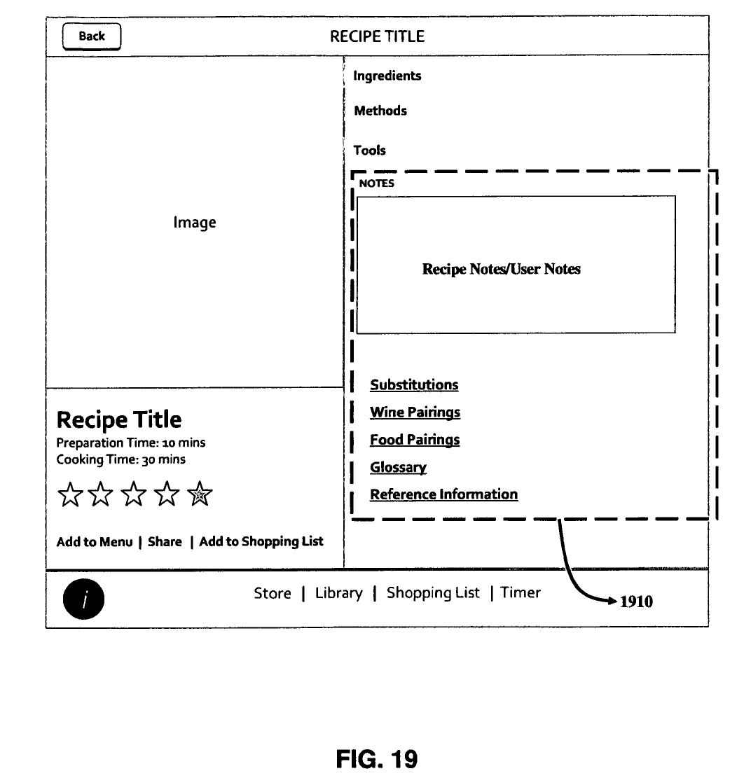

FIG. 19 shows the tools section under recipe detail view. User may access various tools to assist in consuming information and planning for a meal using the selected recipe. As illustrated in highlighted block 1910, user may view publisher's notes, or choose to write down notes for the selected recipe. User may also choose to navigate to various tool views where the system suggests various substitutions for ingredients that are part of the selected recipe, suggests wine pairings that go well with the selected recipe whenever appropriate, suggests food pairings that go well with the selected recipe whenever appropriate, provides glossary for the terms used in the selected recipe, and provides additional reference information for the selected recipe.

In various embodiments suggestions for substitutions, food pairings and wine pairings may be obtained from a pre-mapped information across recipes. In some embodiments, the suggestions for substitutions, food pairings and wine pairings may be obtained by connecting to external premium content and non-premium content sources.

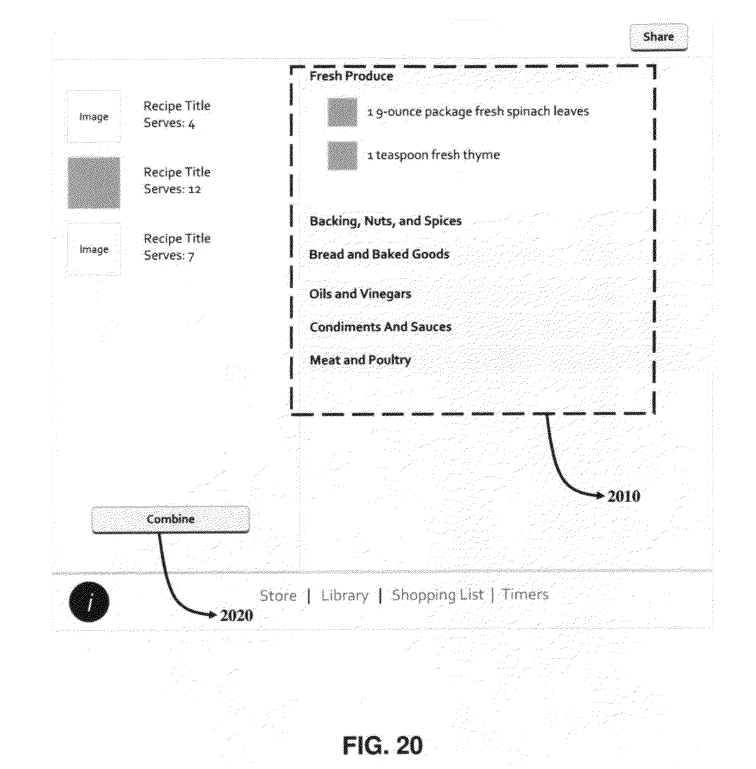

FIG. 20 shows the shopping list view. User may choose one or more recipes and choose to generate shopping list. The shopping list view provides a list of ingredients 2010 for shopping under various pre-defined shopping categories for a selected recipe. User may also have an option to add his own shopping categories and categorize the ingredients based on his convenience.

User may also choose to combine the various ingredients under different recipes selected into a single list using a suitable navigation means 2020.

While the system and methods of the current provide a solution for meal planning and preparation using eSeries, eCookbooks and eRecipes, one skilled in the art can readily see how the embodiments can apply to other similar situations combining steps performed and ingredients, materials, and techniques used such as planning and performing experiments for a science class using eTextbooks and eExperiments or following instructions in an assembly and so on.

The embodiments disclosed herein can be implemented through at least one software program running on at least one hardware device and performing network management functions to control the network elements. Therefore, it is understood that the scope of the protection is extended to such a program and in addition to a computer readable means having instructions therein, such computer readable storage means contain program code means for implementation of one or more steps of the method, when the program runs on a server or mobile device or any suitable programmable device. The hardware device can be any kind of device which can be programmed including e.g. any kind of computer like a server or a personal computer, or the like, or any combination thereof, e.g. one processor and two FPGAs. The device may also include means which could be a hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of providing access to series', cookbooks and recipes to a user through an electronic system, said system comprising a user device and a centralized database, said method comprising
aggregating series, cookbook and recipe information from a plurality of sources;
adding said aggregated series, cookbook and recipe information in said centralized database in a structured format; and
providing access to said aggregated series, cookbook and recipe information in said centralized database through said user device.

2. The method as in claim 1, wherein said structured format comprises
a unique identifier to represent an ingredient set,
a unique identifier to represent an instruction set having a one-to-one relationship with an ingredient set,
a unique identifier to represent a recipe having a one-to-one relationship with an instruction set,
a unique identifier to represent a cookbook having a many-to-many relationship with a recipe, and
a unique identifier to represent a series having a many-to-many relationship with a cookbook.

3. The method as in claim 1, wherein aggregating series, cookbook and recipe information comprises
accessing content from one or more content sources; and
converting content from said one or more sources to said structured format using a conversion tool.

4. The method as in claim 3, wherein said method comprises converting to a pre-defined unit system.

5. The method as in claim 1, wherein said content source is one among publishers, executive chefs, wineries, food companies, caterers, special events, winery dinners, cooking magazines, cooking shows and premium recipe sources.

6. The method as in claim 1, wherein said source is said user using said system.

7. The method as in claim 1, wherein when said user identifies a recipe, presenting one or more tools by said system for looking up one or more terms used in said identified recipe using a glossary tool of said system;
looking up substitutions for one or more ingredients in said identified recipe using a substitutions tool of said system;
looking up wine pairings to go with said identified recipe using a wine pairings tool of said system;
looking up food pairings to go with said identified recipe using a food pairings tool of said system;
looking up additional reference information relating to said identified recipe using a reference tool of said system;
converting unit system for said identified recipe;
scaling said identified recipe according to serving requirements; and
looking up meal analysis information relating to said identified recipe using a meal analysis tool of said system.

8. The method as in claim 1, wherein said method comprises restricting sharing of recipe data stored on said user device over the network.

9. The method as in claim 1, wherein said method comprises providing an option to tag a recipe

10. The method as in claim 1, wherein said method comprises providing an option to add a recipe to favorites.

11. The method as in claim 1, wherein said method comprises providing an option to add a new recipe by a user.

12. The method as in claim 1, wherein said method comprises providing an option to modify an existing recipe and store said modified recipe locally on said user device.

13. The method as in claim 12, wherein said modifications comprise of substitutions, wine pairings, food pairings, unit conversions, scaling, and user notes.

14. The method as in claim 1, wherein said method comprises allowing user to navigate between series, cookbooks, and recipes in a non-linear manner.

15. The method as in claim 1, wherein said method comprises allowing user compare recipes across series and cookbooks.

16. The method as in claim 15, wherein one of said compared recipes is a recipe added by said user.

17. The method as in claim 15, wherein one of said compared recipes is a premium recipe.

18. The method as in claim 1, wherein said method comprises allowing said user to search for series, cookbooks, recipes, reference information, tools and techniques.

19. The method as in claim 1, wherein said method comprises allowing said user to use one or more cooking TIMERS to assist in meal planning and preparation.

20. The method as in claim 1, wherein said method comprises allowing user to buy credits for future use.

21. The method as in claim 1, wherein said method comprises allowing user to buy a portion or whole of one or more of recipes, cookbooks and series through an electronic store.

22. The method as in claim 21, wherein said buying can be done using available credits.

23. A system for providing access to series', cookbooks and recipes to a user, said system comprising:
a user device;
a centralized database;
a means for aggregating series, cookbook and recipe information from a plurality of sources;
a means for adding said aggregated series, cookbook and recipe information in said centralized database in a structured format; and
a means for providing access to said aggregated series, cookbook and recipe information in said centralized database through said user device.

24. The system as claimed in claim 23, wherein said means for aggregating series, cookbook and recipe information comprises
a means for accessing content from one or more content sources; and
a conversion tool for converting content from said one or more sources to said structured format, wherein said conversion tool is configured to convert said content to a predefined unit system.

25. The system as claimed in claim 23, wherein said system comprises a presenting means which when said user identifies a recipe, is configured to provide at least one of
a glossary tool for checking one or more terms used in said one or more recipes;
a substitution tool for checking one or more ingredients in said one or more recipes;
a wine paring tool for checking wine pairings to go with said one or more recipes;
a food paring tool for checking food pairings to go with said one or more recipes;
a reference tool for checking additional information relating to said one or more recipes; and
a meal analysis tool for checking meal analysis information related to said one or more recipes.

26. The system as claimed in claim 23, wherein said system comprises a means for tagging a recipe.

27. The system as claimed in claim 23, wherein said system comprises a navigation means for facilitating said user to navigate between series, cookbooks and recipes in a non-linear manner.

28. The system as claimed in claim 23, wherein said system comprises a means for comparing recipes across series and cookbooks.
